(19) United States
(12) Patent Application Publication
(10) Pub. No.: US 2010/0088401 A1
(43) Pub. Date: Apr. 8, 2010

(54) METHOD OF TRANSFERRING DATA BEING STORED IN A DATABASE

(75) Inventors: Michel DeGraeve, Rhode-Saint-Genese (BE); Nathanaël Ackerman, Bruxelles (BE); Olivier Markowitch, Bruxelles (BE)

Correspondence Address: KNOBBE MARTENS OLSON & BEAR LLP, 2040 MAIN STREET, FOURTEENTH FLOOR, IRVINE, CA, 92614, US

(73) Assignee: Nolink, Braine L'Alleud (BE)

(21) Appl. No.: 12/549,257

(22) Filed: Aug. 27, 2009

Related U.S. Application Data
(63) Continuation of application No. PCT/BE2008/000015, filed on Feb. 28, 2008.
(60) Provisional application No. 60/892,215, filed on Feb. 28, 2007.

(51) Int. Cl. G06F 15/173; H04W 4/12; G06F 17/30; G06F 15/16

(52) U.S. Cl. 709/223; 455/466; 707/705; 709/245

(57) ABSTRACT

Anonymously transferring a selection of content provider data stored in a database, where a subscriber enters into a connection with a telecommunication supplier by sending an identifier of the content provider is disclosed. In one aspect, the telecommunication supplier transmits the identifier together with a reception time and/or a space stamp to a manager. The manager associates: (1) the identifier with an Internet delivery address of the content provider and (2) the time and/or space stamp with a code. The manager transmits delivery information to the telecommunication supplier who then transmits the delivery information to the subscriber. The data selection is transferred by: (1) selecting the Internet delivery address linked to the code or (2) accessing the delivery address with an Internet terminal and entering the code. Upon reception of the code corresponding to the time and/or space stamp, the content provider associates the code with a data selection to make the data selection available for the subscriber.

### RELATED APPLICATIONS

This is a continuation application under 35 U.S.C. §120 of PCT/BE2008/000015 filed on Feb. 28, 2008, and which was published as WO 2008/104039 A2 on Sep. 4, 2008, (and with corrected bibliographic data as shown in WO 2008/104039 A8 published on Jun. 18, 2009), having the title “Method of Transferring Data Being Stored in a Database”, the disclosures of which are hereby incorporated by reference in their entirety. PCT/BE2008/000015 claims the benefit of U.S. Provisional Application No. 60/892,215, filed on Feb. 28, 2007, the disclosure of which is hereby incorporated by reference in its entirety.

### BACKGROUND

1. Field of the Invention

The invention is related to a method for transferring data being stored in a database by using a mobile phone, preferably the database being accessible via the Internet and allows activating access to Internet resources.

2. State of the Art

Since the 1990's, many processes have been described using a mobile phone to deliver any kind of data, both on the mobile phone and on the Internet. All these processes use the mobile phone number (Mobile Station International Subscriber Directory Number (MSISDN) of the mobile user as a key identifier in the transferring process, either to send data directly to her/his mobile phone, or to identify an Internet resource.
In particular, document WO 99/66746 describes the use of the MSISDN number to send a message to the mobile phone;
Documents WO 99/67726; U.S. Pat. No. 6,742,022; U.S. 60/159,083 use the MSISDN number of the data receiver to link it to a delivery URL;
Patents EP-A-0851696; EP-A-1146701; U.S. Pat. No. 5,987,508 link the MSISDN number to an E-mail user and documents WO 01/10089; U.S. Pat. No. 5,987,508 suggests the creation of an E-mail delivery address based on the MSISND.

The common purpose of these processes is to create a unique relationship between each subscriber and the delivery process, either by linking directly the MSISDN to the delivery address, or indirectly using an alias which stands for MSISDN. Some mobile service suppliers, e.g., the French suppliers, cannot directly collect the subscriber's mobile phone number, which is replaced by a unique valid alias which is periodically renewed. It is obvious that the alias is a substitute for the MSISDN to the extent that it identifies each subscriber individually for a determined period of time.

In conclusion, the solutions of the state of the art do not allow to guaranty the anonymity of the subscriber as a unique link is made between the subscriber MSISDN and the delivery process.

### SUMMARY OF CERTAIN INVENTIVE ASPECTS

Certain inventive aspects allow any subscriber to anonymously use his/her mobile phone in order to transfer data on the Internet, using either the moment when the request was performed or the place where the request was performed or either a combination of the time and the place.

In one aspect, there is a method of transferring anonymously a selection of data stored in a database, managed by a content provider, by at least one subscriber who is a mobile phone user, wherein the database is connected to a manager defining a management platform, the manager being connected to one or more application servers and to one or more telecommunication suppliers, and wherein the transfer method comprises entering, by the subscriber, into a connection with one of the telecommunication suppliers by sending an identifier of the content provider as a request; transmitting, by the one of the telecommunication suppliers, at least the identifier, together with at least a reception time stamp and/or a space stamp of the request to the manager; associating, by the manager: (1) the identifier with an Internet delivery address of the content provider and (2) the time stamp and/or the space stamp with a code; transmitting, by the manager, to the one of the telecommunication suppliers delivery information comprising either: (1) the Internet delivery address directly or indirectly linked to the code or (2) the Internet delivery address together with the code, wherein the one of the telecommunication suppliers transmits the delivery information to the subscriber; transferring the data selection by: (1) selecting the Internet delivery address directly or indirectly linked to the code or (2) accessing the delivery address with an Internet terminal and entering the code; and upon reception of the code corresponding to the time stamp and/or the space stamp, associating, by the content provider, the code with a data selection so as to make the data selection available for the subscriber.

The time stamp may be the instant when the request was performed characterized by at least the date, the hour, the minute and the second of the request.

The space stamp may be the location where the request was performed characterized by, for example, the GPS coordinates of the subscriber.

At least two subscribers may transfer the data selection stored in a database managed by a content provider.

The at least two subscribers, having sent the identifier of the content provider, may receive an identical code.

The method may additionally comprise assigning a counter to at least one code.

The method may additionally comprise incrementing the counter by the manager each time the manager receives a time stamp and/or space stamp reception from the telecommunication supplier corresponding to the code.

The method may additionally comprise defining a probability density function by use of an adjustment parameter assigned to each counter, the probability density function being used to determine when the counter will be incremented.

The identifier of the content provider may be sent by the subscriber to the one of the telecommunication suppliers, either: (1) by sending a short message service (SMS) message, (2) by calling, (3) by clicking on a link during an Internet session or (4) by sending an email message to the content provider's mailbox. The identifier of the content provider may be sent by the subscriber to the one of the telecommunication suppliers by any other telecommunication means.

The subscriber may directly send a data selection identifier to a destination dedicated to the content provider, wherein either: (1) the code is sufficient to identify the selection or (2) the manager transmits the code and the data selection identifier to the content provider in order to allow the transfer of the data selection.

The Internet delivery address and the code may be sent by the one of the telecommunication suppliers, either: (1) by sending an SMS message, (2) by calling, (3) by sending information or (4) by redirecting to another application during an Internet session. The Internet delivery address and the code may be sent by the one of the telecommunication suppliers by any other communication or telecommunication means.

The data selection may correspond to a given number of codes.

The one of the telecommunication suppliers may transmit a subscriber's identifier, in addition to the identifier and the time stamp and/or the space stamp, the subscriber's identifier being stored in a temporary database in order to be able to send the Internet delivery address and the code to the subscriber, the subscriber's identifier being deleted immediately after sending the Internet delivery address and the code to the subscriber.

The manager may associate with the code an encrypted or alias code. As soon as the encrypted or alias code is received by the content provider, the content provider may receive or collect the key needed to decrypt the encrypted or alias code, before associating the code to the data selection. The encryption may be performed by the manager using at least two keys.

### BRIEF DESCRIPTION OF THE DRAWINGS

FIG. 1 is a block diagram of an embodiment illustrating the manager operating in a distributed architecture, including an operator, service supplier and content provider, where the manager includes a delivery module.

FIG. 2 is a block diagram of an embodiment illustrating the manager operating in a centralized system, including an operator, service supplier and content provider, where the manager includes a requests management module and a delivery management module.

### DETAILED DESCRIPTION OF CERTAIN INVENTIVE EMBODIMENTS

The following detailed description of certain embodiments presents various descriptions of specific embodiments of the invention. However, the invention can be embodied in a multitude of different ways as defined and covered by the claims. In this description, reference is made to the drawings wherein like parts are designated with like numerals throughout.

The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

The system is comprised of various modules, tools, and applications as discussed in detail below. As can be appreciated by one of ordinary skill in the art, each of the modules may comprise various sub-routines, procedures, definitional statements and macros. Each of the modules are typically separately compiled and linked into a single executable program. Therefore, the following description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system modules, tools, and applications may be written in any programming language such as, for example, C, C++, C#, BASIC, Visual Basic, Pascal, Ada, Java, HTML, XML, or FORTRAN, and executed on an operating system, such as variants of Windows, Macintosh, UNIX, Linux, VxWorks, or other operating system. C, C++, C#, BASIC, Visual Basic, Pascal, Ada, Java, HTML, XML and FORTRAN are industry standard programming languages for which many commercial compilers can be used to create executable code.

The various components of the system may communicate with each other and other components comprising the respective computers through mechanisms such as, by way of example, interprocess communication, remote procedure call, distributed object interfaces, and other various program interfaces. Furthermore, the functionality provided for in the components, modules, and databases may be combined into fewer components, modules, or databases or further separated into additional components, modules, or databases. Additionally, the components, modules, and databases may be implemented to execute on one or more computers.

The present method allows any subscriber to use his/her mobile phone in order to transfer data on the Internet which does not have the drawbacks of the State of the Art. The present method allows any subscriber to use his/her mobile phone in order to transfer anonymously data on the Internet.

The method allows any subscriber to anonymously use his/her mobile phone in order to transfer data on the Internet, using either the moment when the request was performed or the place where the request was performed or a combination of the time and the place or any combination of any physical data that can be acquired by his/her mobile phone.

According to one embodiment, there is a method of transferring anonymously a selection of data stored in a database, managed by a content provider, by at least one subscriber who is a mobile phone user, wherein the database is connected to a manager defining a management platform, the manager being connected to one or more application servers and to one or more telecommunication suppliers, and wherein the transfer method comprises entering, by the subscriber, into a connection with one of the telecommunication suppliers by sending an identifier of the content provider as a request; transmitting, by the one of the telecommunication suppliers, at least the identifier, together with at least a reception time stamp and/or a space stamp of the request to the manager; associating, by the manager: (1) the identifier with an Internet delivery address of the content provider and (2) the time stamp and/or the space stamp with a code; transmitting, by the manager, to the one of the telecommunication suppliers delivery information comprising either: (1) the Internet delivery address directly or indirectly linked to the code or (2) the Internet delivery address together with the code, wherein the one of the telecommunication suppliers transmits the delivery information to the subscriber; transferring the data selection by: (1) selecting the Internet delivery address directly or indirectly linked to the code or (2) accessing the delivery address with an Internet terminal and entering the code; and upon reception of the code corresponding to the time stamp and/or the space stamp, associating, by the content provider, the code with a data selection so as to make the data selection available for the subscriber.

The identifier of the content provider can be sent by the subscriber to the telecommunication supplier, either by sending a short message service (SMS) message, or by calling, or by clicking on a link during an Internet session, or by sending an E-mail to the content provider's mailbox or by any other telecommunication means.

The subscriber can directly send a data selection identifier to a destination dedicated to the Content provider, in this case either the code is sufficient to identify the selection, or the manager transmits the code and the data selection identifier to the content provider in order to allow to collect the selection anonymously.

The delivery address and the code can be sent by the supplier, either by sending an SMS message, or by calling, or by sending information, or by redirecting to another application during an Internet session or by any other communication and/or telecommunication means. Several subscribers, having sent the identifier of the Content provider, can receive an identical code.

The selection can correspond to a given amount of codes.

The telecommunication supplier can transmit the subscriber's identifier, on top of the identifier of the content provider and the time stamp. The subscriber's identifier can be stored in a temporary database in order to be able to send the Internet delivery address and the code to the subscriber. Immediately after sending this information, the subscriber's identifier can be deleted.

The manager can associate with the code an encrypted or alias code. As soon as the encrypted or alias code is received by the content provider, the content provider can receive or collect the key utilized to decrypt the encrypted or alias code, before associating the code to the data selection.

Several subscribers, having sent the identifier to the Content provider at the same time, can receive an identical encrypted or alias code.

Embodiments of the present invention preferably exist in the form of a method, which is available on the Internet. The service is managed by a management platform (hardware/software, named hereinafter manager) that puts in contact content owners or their distributors and all the mobile subscribers.

It is meant by mobile subscriber any mobile phone user, independently from the terminal type he/she is using, hereinafter referred to as subscribers.

The content owner owns a database that he/she can market directly or through a distribution network. The distributor's role consists in distributing contents and getting supplied by one or more content owners (both are referred to as so-called content provider(s)). Content or data are intended as any digital file type: program, text, tone, fixed or animated picture.

The embodiments are distinguished from other distribution systems using data collection as the embodiments advantageously allow the subscriber to protect his/her anonymity when delivering the requested content.

In certain embodiments, only the content provider supplies a method for providing at least two related elements: one identifier, e.g., his name, a word, a phone number (long number, short number, etc.), a URL, etc. and an Internet delivery address from which data can be retrieved (URL).

As the subscriber remains preferably anonymous, this implies that there is no registration procedure nor personal data transfer in order to consult or download data. The intervention of the subscriber is limited to activate the transfer of information and to transfer data:
The subscriber can use all the mobile communication means (call, SMS message, Internet session, etc.) in order to identify the content provider: sending a key word in an SMS message, calling to a specific number, clicking on a link or a button, etc.
The request of the subscriber activates the identification process of a data selection and an Internet delivery address;
Using any Internet terminal, the subscriber can connect to the Web and, depending on the Internet method used to access the data, (e.g., GET or POST methods, or any other Internet access method), either he/she clicks on the URL parameterized with the data identifier, or he/she goes to the supplied Internet address and fills in the identifier in the access form in order to consult and/or download the requested data.

Internet terminal shall be understood as any device that enables to establish and to maintain an Internet session.

### How is the Subscriber's Anonymity Protected?

A characteristic of the method consists in separating the request management (telecommunications aspects) and the data delivery process, using an identifier that has no unique or direct link with the subscriber (MSISDN, IP-address, E-mail, and so forth). During the delivery process, the method utilizes one of the following:
the moment when the request was performed is used as a unique subscriber's identifier; or
the place where the request was performed is used as unique subscriber's identifier;
or a combination of these two parameters—the request time and the request place—is used as unique subscriber's identifier;
or any combination of any physical data that can be acquired by subscriber's mobile phone. The identifier corresponding to the request time and/or to the request place and/or to the request physical data can also be associated to the selection of data.

The different steps in the isolated delivery process management include the following:
In certain embodiments, the manager uses at least two items of information from the telecommunication supplier (mobile operator and/or wireless access service provider) in order to operate the delivery process: the content provider's identifier and the time stamp (date, hour, minute and second, etc.) corresponding to the request reception time and/or the space stamp corresponding to the request place and/or any combination of any stamps corresponding to any physical data that can be acquired by subscriber's mobile phone.
The manager associates the content provider's identifier with the delivery URL and associates the time stamp and/or the space stamp and/or any combination of any physical data that can be acquired by subscriber's mobile phone with a code corresponding respectively to the moment when the request is performed and/or to the place where the request is performed and/or to any combination of any physical data that can be acquired by subscriber's mobile phone.
Depending on the software implementation dedicated to the URL management, the manager transmits to the telecommunication service supplier either the URL, directly or indirectly linked to the code, or the Internet delivery address and the code or any relevant information directly or indirectly linked to the code to access Internet resources. Subsequently the supplier has to transmit both to the subscriber.
Depending on the implementation method dedicated to URL management, the subscriber consults and/or downloads data either by clicking directly on the URL, or by going to the delivery site and encoding the code into the access form.
When receiving the code corresponding to the moment when the request is performed and/or to the place where the request is performed and/or to any physical data acquired when the request was performed, the content provider links or associates the code to a selection of data and makes this available for the subscriber.

The subscriber's anonymity remains effectively protected, as when he/she is consulting and/or downloading data from the content provider's side, he/she is identified only through a code corresponding to request time and/or to the request place and/or to any physical data acquired when the request was performed. This code is not unique, to the extent that several, in particular all, the subscribers who request the data selection at the same time and/or at the same place can receive the same code. The identifier which is originating the request, either MSISND, or IP address, or E-mail, etc. is totally ignored when data are delivered. In certain embodiments, totally ignored means that no unambiguous or univalent link can be establish between a subscriber and its request, without using illegal practices such as a collusion or coalition between the telecommunication supplier and the manager.

The code comprises characters that can be either uppercase or lowercase alphabetic characters (A-Z, a-z), numbers (0-9) or special characters. In certain embodiments, a little more than 6 bits are needed to encode each character. A code of n characters of the above-mentioned 83 possible symbols corresponds to a binary value composed by n*log₂(83) bits.

This method can be implemented in various ways, as demonstrated in the following examples:

### Example 1

Let's imagine a subscriber listening to his favorite radio.
The radio presenter of a program invites his audience to download for free some tracks from the playlist, offered by an advertiser. One just needs to send the name of the radio (content provider's identifier) by SMS message.
The telecommunication supplier collects the subscriber's MSISDN, the name of the radio and the SMS time stamp (e.g., December 10, 14 hours 21 minutes and 43 seconds). The supplier only transmits the name of the radio and the time stamp to the manager.
From this information, the manager associates the content provider's identifier with the Internet delivery address (www.nameoftheradio.com) and determines the code corresponding to the moment when the request was performed, e.g., 12.10.14.21.43.
The code and the URL are transmitted to the telecommunication supplier, who sends them back to the subscriber, referring to the MSISDN number, e.g., in an SMS message.
Connecting with any Internet terminal, the subscriber goes to the site www.nameoftheradio.com and fills in the code in an access form.
The application server of the radio website associates the code corresponding to the moment when the request was performed to the music that was played on the radio at the same time, or to the playlist of the program broadcast when the SMS message was sent, or to the daily playlist, and so forth.
The subscriber consults the playlist and downloads the selected track; meanwhile he/she is displaying the commercial from the advertiser.

Depending on the mobile telecommunication means selected by the content provider in order to send his identifier, data transmission and delivery can occur in different forms. Going back to the example, one can encounter the following situations:
The subscriber calls to an Interactive Voice Response (IVR) system of the radio station and receives a standard SMS message mentioning the Internet delivery address in the selected implementation format.
The subscriber calls to the radio station's IVR system or sends an SMS message with the name of the radio and receives a wireless access protocol (WAP) push SMS comprising the URL parameterized with the code corresponding to request time and from which he/she will be able to consult the playlist and/or download the selected track.
The subscriber listens to the radio on line via his mobile phone, clicks on the browser download button that is especially developed, a window opens and the window URL parameters are based on the code corresponding to the clicking time stamp. The subscriber can either consult all the playlist or part of it and downloads the selected track, or a commercial is displayed while the musical track is downloaded on his/her terminal. In any case, the click on the button stands for identifying the content provider and the temporary IP address is used only to send the URL parameterized with the code corresponding to request time. The subscriber remains anonymous for the content provider.

In certain embodiments, in all the variations presented above, all the subscribers who are sending or selecting data at the same time receive the same code and all of them access the same URL associated with the same code. The radio station can count the amount of sent URLs associated with the same code and can decide to limit the download amount to this threshold in order to avoid misuse.

### Example 2

Let's further suppose an advertiser would use advertising panels in order to invite consumers to send a request by means of their mobile phones (as described in one of the afore-mentioned methods) for downloading from its Web site a hitherto unpresented, successful TV-series. Any subscriber who would pass by the same advertisement would receive the same identifying code, respective to the place of request, or any subscriber who would pass by the same advertisement at the same time would receive an identical code.

A list of examples for this application could be endlessly continued.

### Encryption:

The code can be produced from the time stamp and/or the space stamp by means of cryptographic methods such as pseudo-random bit generator (PRBG), hash functions or security key encryption algorithms.

In certain embodiments, a secret key encryption algorithm can be used to produce the codes. For example, the following way can be used: code=E (k, time stamp and/or space stamp) where E( ) is the encryption function (AES for example) and k is the secret encryption key.

Alternatively, PRGB can be used to generate binary sequences of arbitrary length. When the content provider receives a time stamp and/or a space stamp, it generates a random binary value. The content provider stores the correspondence between the time stamp and/or the space stamp and the produced random binary value.

Alternatively, a cryptographic hash function based on a secret key (also known as “message authentication code” or MAC) can be used to produce, on the basis of an input value, an output value that looks like a random value. In this case, one would have code=h (k, time stamp and/or space stamp) where h( ) is the hash function and k the secret key utilized to compute the result.

When using a code produced by the means of a keyed hash function or of an encryption function, the secret key used to compute the function is transmitted to the content provider.

In certain embodiments, the same key can be used to encrypt all the code produced for the same content provider during a certain period of time. The key is initially shared between the manager and the content provider.

In certain embodiments, when using an encryption function, the only required communication between the manager and the content provider is sending the encryption key. Alternatively, when using a keyed hash function, the service provider receives from the manager the encryption key and the time stamps and/or the space stamps of the received request, in order for the service provider to be able to compare the code provided by the subscriber with hashes of the received time stamps and/or space stamp.

Moreover, in order to avoid misuse, again, the code sent to the subscriber can be encrypted or linked or associated to an alias code in such a way that the time stamp and/or the space stamp and/or any acquired physical data cannot be deduced from the code. Afterwards, the decrypted code can be associated with a selection of the database.

### Example 3

Alternatively, it is possible to modify the code derived from the time stamp in order to have a single use code. Such an implementation of the method associates a counter to the code. In certain embodiments, the access to the requested selection of data is only allowed one time per counter increment.

The different steps of this implementation are the following:
The subscriber sends a request for data transfer.
The telecommunication supplier sends the content identifier and a time stamp and/or a space stamp to the manager.
The manager associates a code to this time stamp and/or this space stamp received from the telecommunication supplier.
If it is the first time that the manager uses this code, the manager set the counter to one. If the code was already used, the manager increments by one the counter associated to this code. If the counter reaches its maximum value, no new code is produced anymore.
The manager computes the concatenation of the code and the counter. Afterwards, the manager calculates the code1=E_k1 (code, counter), k1 being a secret key shared between the manager and the content provider. In certain embodiments, a secret key is dedicated to each set of data.
The manager sends the encrypted code (code1), the corresponding time stamp and/or space stamp, and the Internet delivery address to the telecommunication supplier. The telecommunication supplier selects one MSISDN from the set of MSISDN that are associated with the corresponding time stamp and/or space stamp. The telecommunication supplier tags the selected MSISDN as already used and sends a message comprising the code1 and the Internet delivery address to the subscriber to which the chosen MSISDN corresponds.
The subscriber goes to the Internet delivery address and enters the code1.
The content provider decrypts the code1 thanks to the secret key k1 shared with the manager and retrieves the time stamp and the counter.
If the value of the counter was not already used for this code, the access is granted, otherwise the access is denied.

The here above described implementation allows to readily control the amount of connections to the selectable data. Moreover, this implementation prevents illicit connections to the service with stolen codes.

Alternatively, the increment of the counter can be tuned using an adjustment parameter. Each counter can have its own adjustment parameter. The parameter defines a probability density function that is used to determine when the counter will be incremented.

### Example 4

In case of coalition or collusion between the telecommunication supplier and the content provider, a list of mobile phone numbers (MSISDN) associated to a given code can be retrieved. An implementation of the present method based on a two encryption keys system can avoid retrieving of such a list.

The different steps of this implementation are the following:
The subscriber sends a request for data transfer; the telecommunication supplier sends the content identifier and a time stamp and/or a space stamp to the manager.
The manager associates a code to this time stamp and/or this space stamp received from the telecommunication supplier.
The manager chooses a secret key—namely k1—only known by it and calculates the code1 (code1=E_k1 (code, counter)) and increments the counter. The code1 and the manager Internet address are sent to the telecommunication supplier and then forwarded to the subscriber.
The subscriber connects to the Internet address received from the telecommunication supplier and enters the code1, along with the content identifier if not integrated in code1.
The manager deciphers code1—using key k1—and recovers thereby the code, the counter and eventually the content identifier. If the information recovered are valid, a new encryption step generates code2 (code2=E_k2 (code, counter)), k2 being a secret key shared between the manager and the content provider. The code2 and an Internet delivery address are displayed on the Internet page.
The subscriber accesses the Internet delivery address and he/she enters the code2 on this Internet page.
The content provider deciphers code2—using shared secret key k2—and recovers the code and the counter. After verification of the recovered data, the content provider authorizes the access to the requested data to the subscriber.

In case of coalition or collusion between the telecommunication supplier and the content provider, no information about the subscriber can be derived. Indeed, code1 is accessible to the telecommunication supplier while code2 is not. The content provider, on the contrary, has access to code2 exclusively. Therefore, no link can be made between code2 and code1, and per se between code2 and the subscriber MSISDN.

The here above-mentioned implementation requires the access to two different Internet pages. Therefore, it can be seen as complicated and time consuming to the subscriber. A suitable alternative replaces the manager Internet page by an application—such as a Java® applet—present on an Internet page of the content provider accessed thanks to the Internet delivery address.

The different steps of this alternative implementation are the following:
The subscriber sends a request for data transfer; the telecommunication supplier sends the content identifier and a time stamp and/or a space stamp to the manager.
The manager associates a code to this time stamp and/or this space stamp received from the telecommunication supplier. The manager chooses a secret key—namely k1—only know by it and calculates the code1 (code1=E_k1 (code, counter)) and increments the counter. The code1 and the Internet delivery address are sent to the telecommunication supplier and then forwarded to the subscriber.
The subscriber connects to the Internet delivery address received from the telecommunication supplier. An application present on the Internet delivery page invites the subscriber to enter the code received from the telecommunication supplier—namely the code1—, along with the content identifier if not integrated in code1.
The manager deciphers code1—using a secret key k1—and recovers thereby the code, the counter and eventually the content identifier. If the information recovered is valid, a new encryption step generates code2 (code2=E_k2 (code, counter)), k2 being a secret key shared between the manager and the content provider. Afterwards, the code2 is sent by the manager to the content provider using a request, such as a POST request, comprising the code2.
The content provider deciphers code2—using shared secret key k2—and recovers the code, the counter and eventually the content identifier. After verification of the recovered data, the content provider authorizes the access to the requested selection of data to the subscriber.

The subscriber could also send the identifier of a data selection (the title of a musical track, for example) instead of the content provider's identifier. The request destination is, in this example, the short number, a URL that locates a Web resource. The next steps of the process differ according to the use:
Either the management process remains unchanged as the code corresponding to a request time also identifies the data selection;
Or the code does not determine specific data but is only used to protect a subscriber's anonymity. In this case, when the subscriber accesses the Internet delivery address, the manager transmits to the content provider the data selection identifier matching with the code corresponding to the request. The transmission mode will depend on the interface type used between the applications.

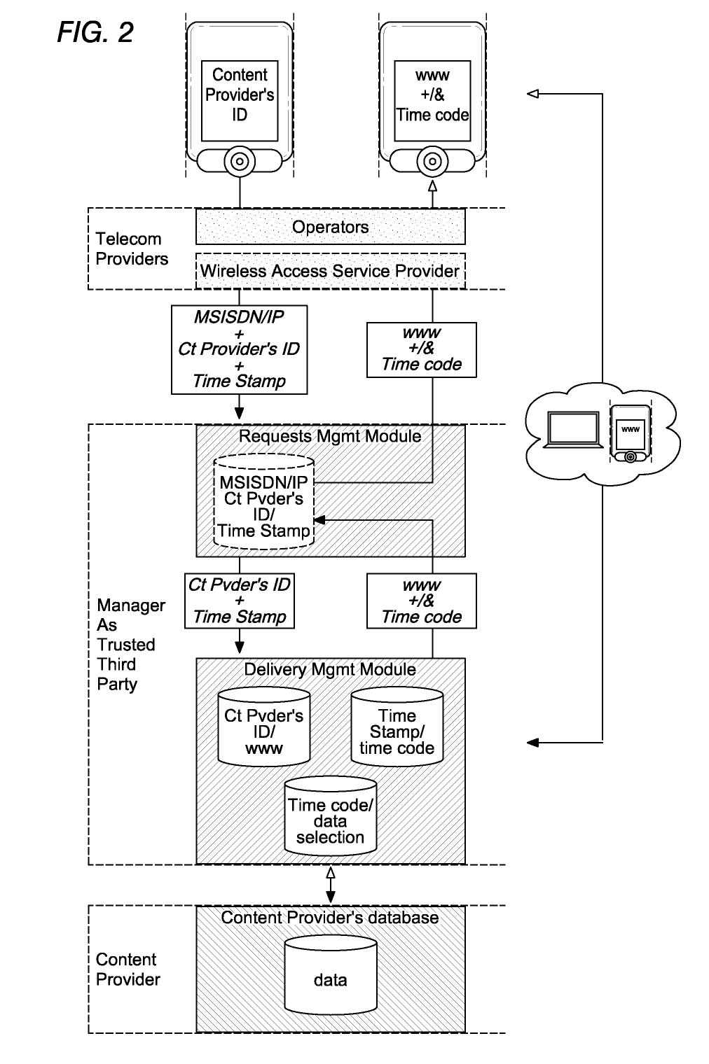

Today, the transactions between operators, access providers and service suppliers are based on a single identifier: the subscriber's MSISDN number. Referring to FIG. 2, in these circumstances and until operational procedures are modified, the service Manager acts as a Trusted Third Party as follows: a module dedicated to requests management collects the subscriber's MSISDN number (and/or the temporary IP address), the request time stamp and the content provider's identifier from the telecommunication provider and stores them in a temporary database. The latter data are temporarily stored in order to answer to the subscriber. The manager transfers the request time stamp and the content provider's identifier to a delivery management module. The manager receives the Internet delivery address from the delivery management module, according to the implementation methods described above. The manager sends the Internet delivery address to the subscriber and destroys the information related to the subscriber.

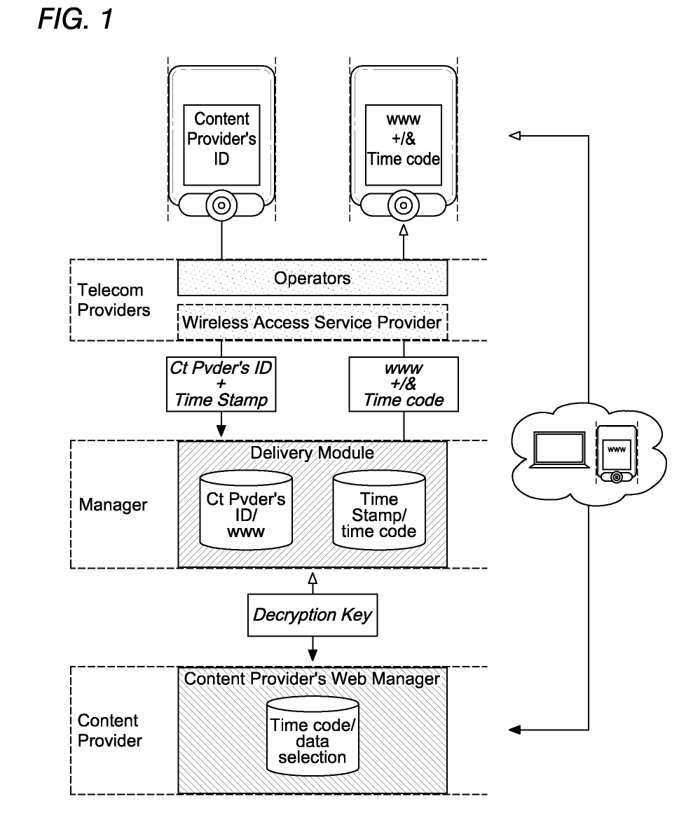

According to the operating methods, the manager can operate in a distributed architecture, an example of which is shown in FIG. 1, spread between the different acting parties concerned, operator, service supplier, content providers (refer to the example with the radio station). Alternatively, the manager can be implemented in a centralized system, an example of which is shown in FIG. 2. In the centralized system case, the manager includes both the requests management and the delivery management modules. It can also manage web delivery functionality by transferring the contents to be delivered from the content providers' side.

The above-described methods may be realized in a program format to be stored on a computer readable recording medium that includes any kinds of recording devices for storing computer readable data, for example, a CD-ROM, a DVD, a magnetic tape, memory card, and a disk, and may also be realized in a carrier wave format (e.g., Internet transmission or Bluetooth transmission).

### CONCLUSION

While specific blocks, sections, devices, functions and modules may have been set forth above, a skilled technologist will realize that there are many ways to partition the system, and that there are many parts, components, modules or functions that may be substituted for those listed above.

While the above detailed description has shown, described, and pointed out the fundamental novel features of the invention as applied to various embodiments, it will be understood that various omissions and substitutions and changes in the form and details of the system illustrated may be made by those skilled in the art, without departing from the intent of the invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A method of transferring anonymously a selection of data stored in a database, managed by a content provider, by at least one subscriber who is a mobile phone user, wherein the database is connected to a manager defining a management platform, the manager being connected to one or more application servers and to one or more telecommunication suppliers, and wherein the transfer method comprises:
entering, by the subscriber, into a connection with one of the telecommunication suppliers by sending an identifier of the content provider as a request;
transmitting, by the one of the telecommunication suppliers, at least the identifier, together with at least a reception time stamp and/or a space stamp of the request to the manager;
associating, by the manager: (1) the identifier with an Internet delivery address of the content provider and (2) the time stamp and/or the space stamp with a code;
transmitting, by the manager, to the one of the telecommunication suppliers delivery information comprising either: (1) the Internet delivery address directly or indirectly linked to the code or (2) the Internet delivery address together with the code, wherein the one of the telecommunication suppliers transmits the delivery information to the subscriber;
transferring the data selection by: (1) selecting the Internet delivery address directly or indirectly linked to the code or (2) accessing the delivery address with an Internet terminal and entering the code; and
upon reception of the code corresponding to the time stamp and/or the space stamp, associating, by the content provider, the code with a data selection so as to make the data selection available for the subscriber.

16. The method according to claim 15, wherein at least two subscribers transfer the data selection stored in a database managed by a content provider.

17. The method according to claim 16, wherein the at least two subscribers, having sent the identifier of the content provider, receive an identical code.

18. The method according to claim 16, additionally comprising assigning a counter to at least one code.

19. The method according to claim 18, additionally comprising incrementing the counter by the manager each time the manager receives a time stamp and/or space stamp reception from the telecommunication supplier corresponding to the code.

20. The method according to claim 18, additionally comprising defining a probability density function by use of an adjustment parameter assigned to each counter, the probability density function being used to determine when the counter will be incremented.

21. The method according to claim 16, wherein the identifier of the content provider is sent by the subscriber to the one of the telecommunication suppliers, either: (1) by sending a short message service (SMS) message, (2) by calling, (3) by clicking on a link during an Internet session or (4) by sending an email message to the content provider's mailbox.

22. The method according to claim 21, wherein the identifier of the content provider is sent by the subscriber to the one of the telecommunication suppliers by any other telecommunication means.

23. The method according to claim 16, wherein the subscriber directly sends a data selection identifier to a destination dedicated to the content provider, wherein either: (1) the code is sufficient to identify the selection or (2) the manager transmits the code and the data selection identifier to the content provider in order to allow the transfer of the data selection.

24. The method according to claim 16, wherein the Internet delivery address and the code are sent by the one of the telecommunication suppliers, either: (1) by sending an SMS message, (2) by calling, (3) by sending information or (4) by redirecting to another application during an Internet session.

25. The method according to claim 24, wherein the Internet delivery address and the code are sent by the one of the telecommunication suppliers by any other communication or telecommunication means.

26. The method according to claim 16, wherein the data selection corresponds to a given number of codes.

27. The method according to claim 16, wherein the one of the telecommunication suppliers transmits a subscriber's identifier, in addition to the identifier and the time stamp and/or the space stamp, the subscriber's identifier being stored in a temporary database in order to be able to send the Internet delivery address and the code to the subscriber, the subscriber's identifier being deleted immediately after sending the Internet delivery address and the code to the subscriber.

28. The method according to claim 16, wherein the manager associates with the code an encrypted or alias code.

29. The method according to claim 28, wherein as soon as the encrypted or alias code is received by the content provider, the content provider receives or collects the key needed to decrypt the encrypted or alias code, before associating the code to the data selection.

30. The method according to claim 28, wherein the encryption is performed by the manager using at least two keys.
